(19) United States
(12) Patent Application Publication
(10) Pub. No.: US 2026/0284875 A1
(43) Pub. Date: Sep. 24, 2026

(54) JOINT MECHANISM UNIT AND ROBOT

(71) Applicant: FANUC CORPORATION, Minamitsuru-gun, Yamanashi (JP)

(72) Inventors: Shunichi ODAKA, Minamitsuru-gun, Yamanashi (JP); Kazutaka NAKAYAMA, Minamitsuru-gun, Yamanashi (JP)

(73) Assignee: FANUC CORPORATION, Minamitsuru-gun, Yamanashi (JP)

(21) Appl. No.: 18/996,187

(22) PCT Filed: Jan. 30, 2023
(86) PCT No.: PCT/JP2023/002874

§ 371 Date: Jan. 17, 2025

(51) Int. Cl. B25J 9/16; B25J 13/08; B25J 19/00

(52) U.S. Cl. CPC B25J 9/1633; B25J 13/085; B25J 19/0029; G05B 2219/31142; G05B 2219/39001

(57) ABSTRACT

This joint mechanism unit comprises a fixed unit, a rotating unit, a motor, a motor control unit, and a force sensor that detects force acting about a joint shaft. A single wire body connected to the motor control unit and the force sensor passes through a hollow hole formed in at least a portion of the joint mechanism unit.

### TECHNICAL FIELD

The present invention relates to a joint mechanism and a robot.

### BACKGROUND ART

The joint mechanism of a vertically articulated robot mechanism primarily comprises a motor, a motor control unit for controlling the motor, and a force sensor for detecting force acting around the rotation axis of a rotating part rotated by the motor. The motor control unit is conventionally arranged at one end of the joint mechanism, and the force sensor is frequently arranged at the other end of the joint mechanism. An umbilical member passes through a hollow hole formed in the joint mechanism.

The umbilical member may comprise a cable for motor operation commands and a cable for the force sensor (for example, Japanese Unexamined Patent Publication (Kokai) No. 2019-089143).

### CITATION LIST

### Patent Literature

PTL 1: Japanese Unexamined Patent Publication (Kokai) No. 2019-089143

### SUMMARY OF INVENTION

### Technical Problem

The smaller the cross-sectional area of the hollow hole of the joint mechanism, the more compact the entire joint mechanism can be. Thus, there is a demand for joint mechanisms and robot which can reduce the number of umbilical members passing through the hollow hole of the joint mechanism to provide greater margin in the cross-sectional area of the hollow hole.

### Solution to Problem

According to a first aspect of the present disclosure, there is provided a joint mechanism and a robot capable of reducing the number of umbilical members passing through the hollow hole to provide greater margin in the cross-sectional area of the hollow hole.

The objects, features, and advantages of the present disclosure will become more apparent from the following description of the embodiments taken in conjunction with the accompanying drawings.

### BRIEF DESCRIPTION OF DRAWINGS

FIG. 1 is a side view of a joint mechanism based on a first embodiment.

FIG. 2 is a block diagram of the joint mechanism based on the first embodiment.

FIG. 3A is a block diagram of a robot comprising the joint mechanism of the first embodiment.

FIG. 3B is a block diagram of a robot comprising the joint mechanism of another modification example.

FIG. 4 is a side view of a joint mechanism based on a second embodiment.

FIG. 5 is a block diagram of the joint mechanism based on the second embodiment.

FIG. 6 is a block diagram of a robot comprising the joint mechanism of the second embodiment.

FIG. 7 is a block diagram of a joint mechanism based on a third embodiment.

FIG. 8 is a block diagram of a robot comprising the joint mechanism of the third embodiment.

FIG. 9A is a view showing a first modification example, in which an umbilical member comprises a control communication power supply bus.

FIG. 9B is a view showing a second modification example, in which an umbilical member comprises a control communication power supply bus.

FIG. 9C is a view showing a third modification example, in which an umbilical member comprises a control communication power supply bus.

FIG. 9D is a view showing a fourth modification example, in which an umbilical member comprises a control communication power supply bus.

FIG. 10A is a block diagram of a joint mechanism of another modification example.

FIG. 10B is a block diagram of a joint mechanism of yet another modification example.

FIG. 10C is a perspective view of the joint mechanism shown in FIG. 10B.

FIG. 11A is a side view of a portion of a robot comprising a joint mechanism based on a fourth embodiment.

FIG. 11B is a view showing a first modification example of the fourth embodiment.

FIG. 11C is a view showing a second modification example of the fourth embodiment.

FIG. 11D is a view showing a third modification example of the fourth embodiment.

FIG. 11E is a view showing a fourth modification example of the fourth embodiment.

FIG. 11F is a view showing a fifth modification example of the fourth embodiment.

FIG. 11G is a view showing a sixth modification example of the fourth embodiment.

FIG. 12A is a side view of a portion of a robot comprising a joint mechanism of a fifth embodiment.

FIG. 12B is a view showing a modification example of the fifth embodiment.

FIG. 13A is a perspective view of a robot comprising a joint mechanism.

FIG. 13B is a perspective view of another robot comprising a joint mechanism.

FIG. 14A is a side view of a portion of a robot comprising a joint mechanism of the prior art.

FIG. 14B is a block diagram of the joint mechanism of FIG. 14A.

FIG. 15A is a side view of a portion of a robot comprising another joint mechanism of the prior art.

FIG. 15B is a block diagram of the other joint mechanism of FIG. 15A.

### DESCRIPTION OF EMBODIMENTS

The embodiments of the present disclosure will be described below with reference to the accompanying drawings. In the drawings, corresponding components have been assigned common reference signs.

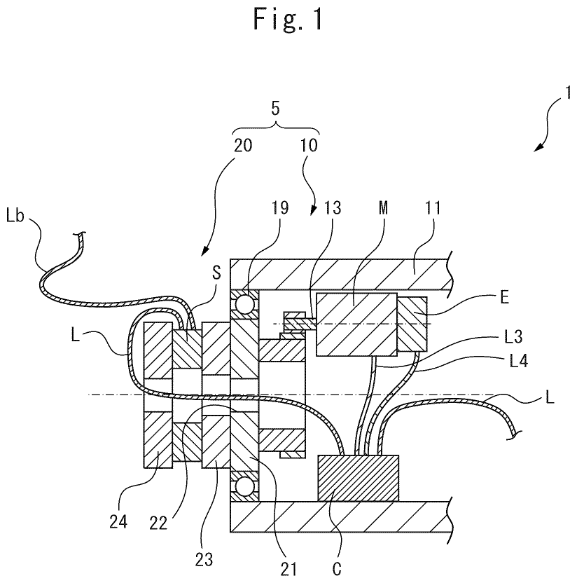

FIG. 1 is a side view of a joint mechanism based on a first embodiment. The joint mechanism 5 primarily comprises a fixed part 10 and a rotating part 20 which rotates relative to the fixed part 10. The rotation axis of the rotating part 20 relative to the fixed part 10 is the same as the joint axis of the joint mechanism 5.

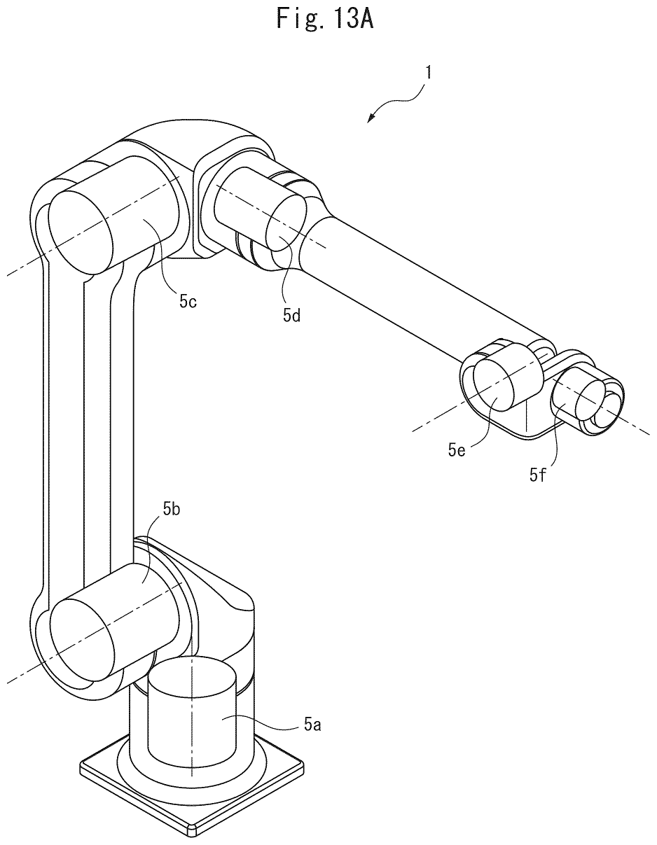

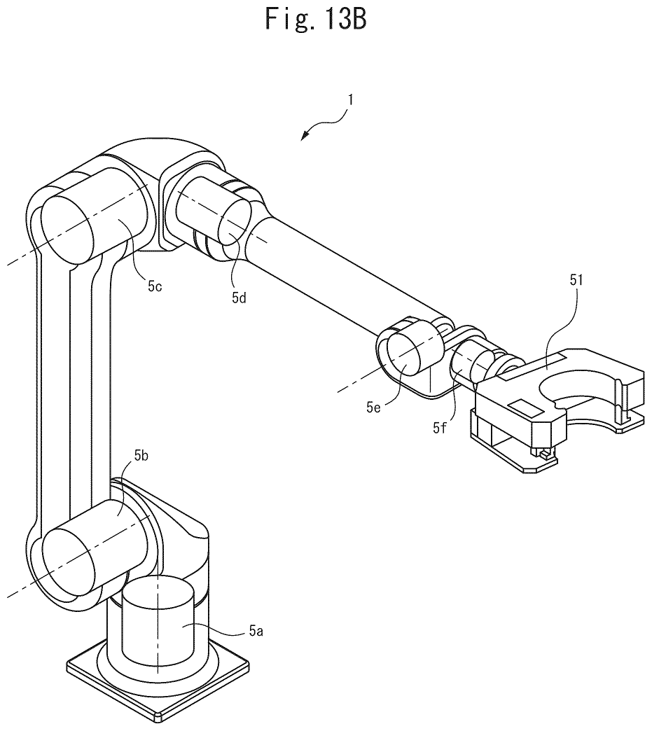

The joint mechanism 5 may be incorporated in a joint portion of a robot 1, for example, a vertical articulated robot. FIG. 13A is a perspective view of a robot comprising a joint mechanism. The six-axis joint robot 1 shown in FIG. 13A comprises six joint mechanisms 5a to 5f. Alternatively, the joint mechanism 5 may be incorporated in a machine different from the robot 1, for example, a machine tool.

As shown in FIG. 1, the fixed part 10 comprises a housing 11 to be affixed to an object, for example, a first link (not illustrated). A bearing 19 is arranged at one end of the housing 11. A motor M for rotating the rotating part 20, an encoder E for detecting the position of an output shaft 13 of the motor M, and a motor control unit C for controlling the motor M using the detection results of the encoder E are arranged in the housing 11. The motor control unit C may be a computer comprising a processor, memory, etc. The motor M and the encoder E are connected to the motor control unit C by umbilical members L3 and L4, respectively. In the drawings described later, illustration of the umbilical members L3 and L4 may be omitted.

The rotating part 20 comprises a reduction output end of a speed reducer 21 which is rotatably supported by the bearing 19, and a force sensor S for detecting force acting around the joint axis. As shown in the drawing, one end of the speed reducer 21 is rotatably engaged with the output shaft 13 of the motor M within the housing 11.

In FIG. 1, the speed reducer 21 is connected to the force sensor S via a first connection member 23. The speed reducer 21 reduces the rotation of the output shaft 13 of the motor M by a predetermined reduction ratio and transmits the rotation to the first connection member 23. The force sensor S is connected to a second link (not illustrated) via a second connection member 24.

The force sensor S is constituted by, for example, a torque sensor for detecting force acting around the joint axis. The force sensor S preferably has a spring part (not illustrated) which exhibits spring properties. Since the spring part deforms when a force acts around the joint axis of the joint mechanism 5, the force acting around the joint axis can be detected via the deformation amount of the spring part. The force sensor S may be of a strain gauge type, a capacitance type, a magnetic type, an optical encoder type, etc.

In a modification example, at least one of the first connection member 23 and the second connection member 24 may be removed. Thus, the speed reducer 21 may be directly connected to the force sensor S, or the force sensor S may be directly connected to the second link A2 (not illustrated). As will be described later, the positional relationship between the motor M, the motor control unit C, and the force sensor S is not limited to that described above.

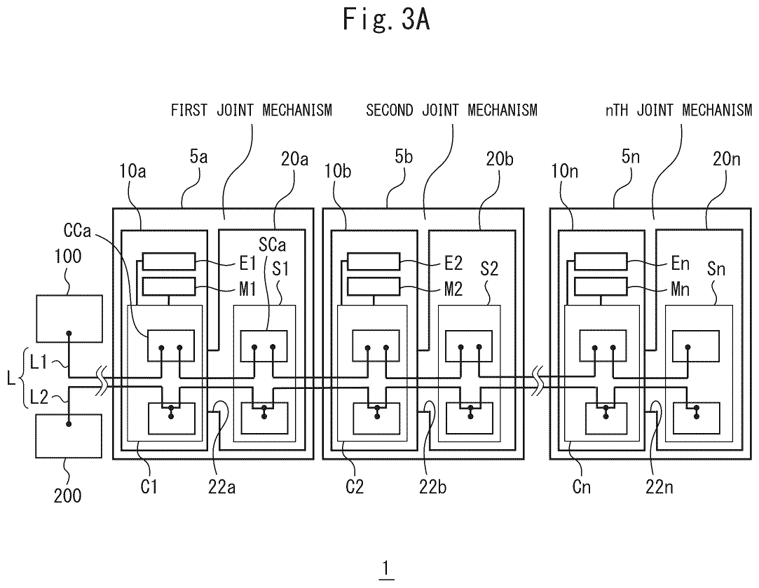

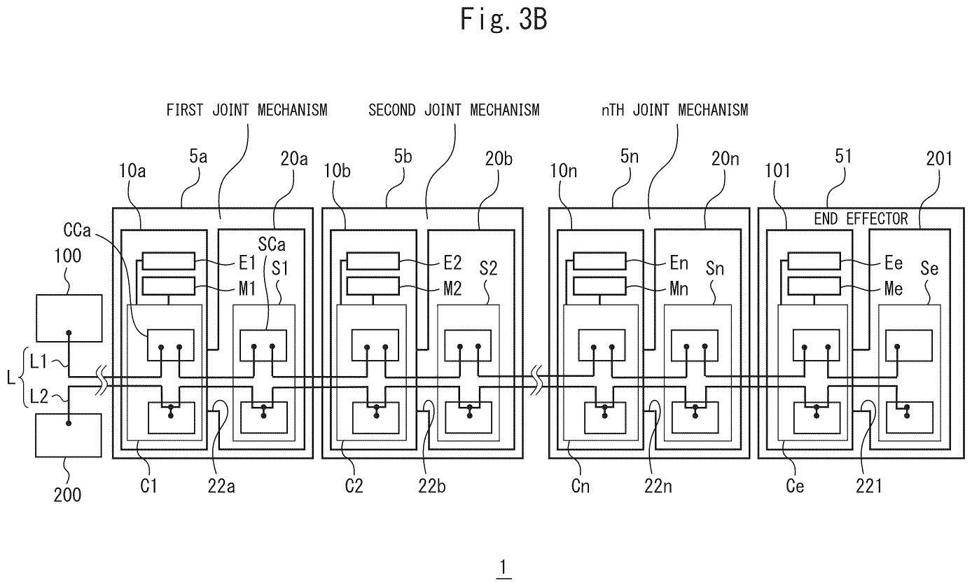

Furthermore, an umbilical member L extending from a host control unit 100 (refer to FIG. 3A) is connected to the motor control unit C. The host control unit 100 is a computer comprising a processor, memory, etc., and may be, for example, a robot control unit for controlling the robot 1.

The speed reducer 21, the first connection member 23, the force sensor S, and the second connection member 24 of the rotating part 20 have a hollow structure and form a common hollow hole 22. The umbilical member L extending from the motor control unit C passes through the hollow hole 22 of the rotating part 20 and is connected to the force sensor S. Furthermore, the umbilical member L extending from the force sensor S is connected to the motor control unit C (not illustrated) of an adjacent joint mechanism 5 (not illustrated in FIG. 1). It should be noted that the configuration of the hollow hole 22 is not limited to that described above.

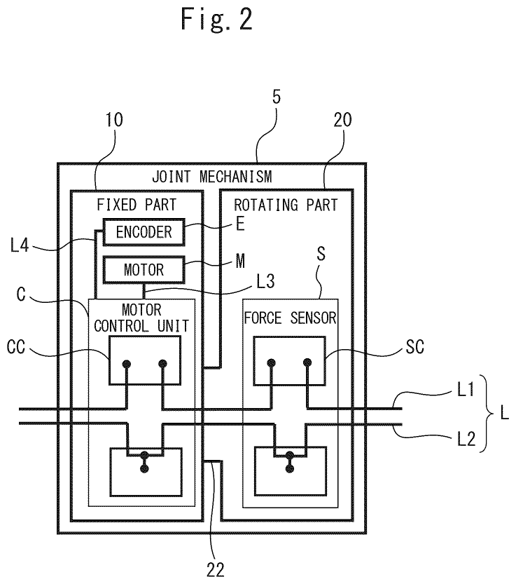

FIG. 2 is a block diagram of the joint mechanism based on the first embodiment, and FIG. 3A is a block diagram of a robot comprising the joint mechanism of the first embodiment. As shown in FIG. 2, the motor control unit C includes a communication unit CC. The communication unit CC enables the motor control unit C to communicate with other motor control units, the host control unit 100, and the force sensor S via the umbilical member L. The communication unit CC may perform various arithmetic processing as the motor control unit C. Furthermore, the force sensor S includes a communication unit SC. Likewise, the communication unit SC enables the force sensor S to communicate with the motor control unit C, the host control unit 100, and other force sensors via the umbilical member L.

The umbilical member L shown in FIG. 2 comprises a data line L1 and a power supply bus L2. The umbilical member L is a single umbilical member configured by integrally combining the data line L1 and the power supply bus L2. The umbilical member L may be configured by integrally combining other buses or lines in addition to the data line L1 and the power supply bus L2. The data line L1 and the power supply bus L2 have the same communication protocol, and this also applies to the embodiments and modification examples described later.

The data line L1 and the power supply bus L2 may each be an Ethernet (registered trademark) cable, a USB cable, an optical fiber, or an HDMI (registered trademark) cable. In other words, the term “bus” as used herein refers to a signal transmission path and may include any concept such as a line or a bar. The umbilical member L may transmit and receive data and/or current between one or more joint mechanisms 5 and the like by wire in a known manner based on a command from the host control unit 100 (refer to FIG. 3A). It should be noted that another umbilical member Lb extending from the force sensor S shown in FIG. 1, etc., has the same configuration as the umbilical member L.

As shown in FIG. 2, the data line L1 is daisy chain-connected to the communication unit CC of the motor control unit C of the joint mechanism 5 and the communication unit SC of the force sensor S. The left end of the data line L1 of FIG. 2 is connected to the host control unit 100 (refer to FIG. 3A), and various data are transmitted and received between the host control unit 100 and the joint mechanism 5. The various data include control information such as command values related to the motor M created by the motor control unit C and the host control unit 100, and detection data detected by the encoder E. The data line L1 can be a full-duplex communication line having bidirectional signal lines for bidirectional communication, a half-duplex communication line that switches the communication direction in a time-division manner, or a parallel communication line.

As shown in FIG. 2, the power supply bus L2 is bus-connected to the motor control unit C and the force sensor S of the joint mechanism 5. The left end of the power supply bus L2 in FIG. 2 is connected to the power supply unit 200 (refer to FIG. 3A), and serves to supply the current from the power supply unit 200 to the motor control unit C and the force sensor S of the joint mechanism 5. The motor control unit C and the force sensor S are driven by the current supplied via the power supply bus L2. The power supply bus L2 may be a DC positive/negative two-wire. The power supply bus L2 may supply single-phase AC or polyphase AC. Furthermore, the status of the power supply unit 200 and the supply status of the power supply unit 200 can be superimposed and communicated via the power supply bus L2.

For the sake of brevity, the communication units CC and SC may be omitted in the following description, and likewise, the communication units CC and SC may be omitted in the following description, except in FIG. 2 (and part of FIG. 3A).

The umbilical member L on the upstream side (the host control unit 100 and power supply unit 200 side) of the joint mechanism 5 is an umbilical member in which the data line L1 and the power supply bus L2 are integrally combined. When the joint mechanism 5 is connected to another device, for example, another joint mechanism, the umbilical member L on the downstream side of the joint mechanism 5 between the joint mechanism 5 and another indirect mechanism is also an umbilical member in which the data line L1 and the power supply bus L2 are integrally combined.

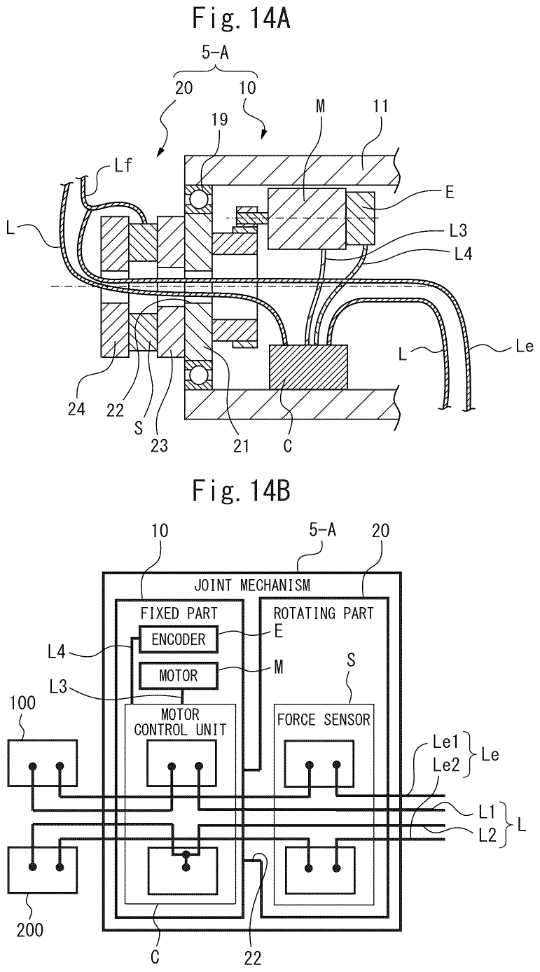

FIG. 14A is a side view of a part of a robot comprising a joint mechanism of the prior art, and FIG. 14B is a block diagram of the joint mechanism of FIG. 14A. The umbilical member L of the joint mechanism 5-A is an umbilical member which comprises a data line L1 and a power supply bus L2 in the manner as described above. This umbilical member L has a portion which extends from the motor control unit C through the hollow hole 22 of the joint mechanism 5-A.

Another umbilical member Le passes through the hollow hole 22 of the joint mechanism 5-A. The other umbilical member Le comprises a data line Le1 for connecting the host control unit 100 and the force sensor S, and a power supply bus Le2 for connecting the power supply unit 200 and the force sensor S. The other umbilical member Le is an umbilical member having a configuration in which the data line Le1 and the power supply bus Le2 are integrally combined. Yet another umbilical member Lf extends from the force sensor S toward the outside of the joint mechanism 5-A. The other umbilical member Lf has approximately the same configuration as the other umbilical member Le.

In the prior art as shown in FIGS. 14A and 14B in this manner, the umbilical members L and Le each comprise a data line L1, Le1 and a power supply bus L2, Le2. Thus, the umbilical members L and Le are relatively thick.

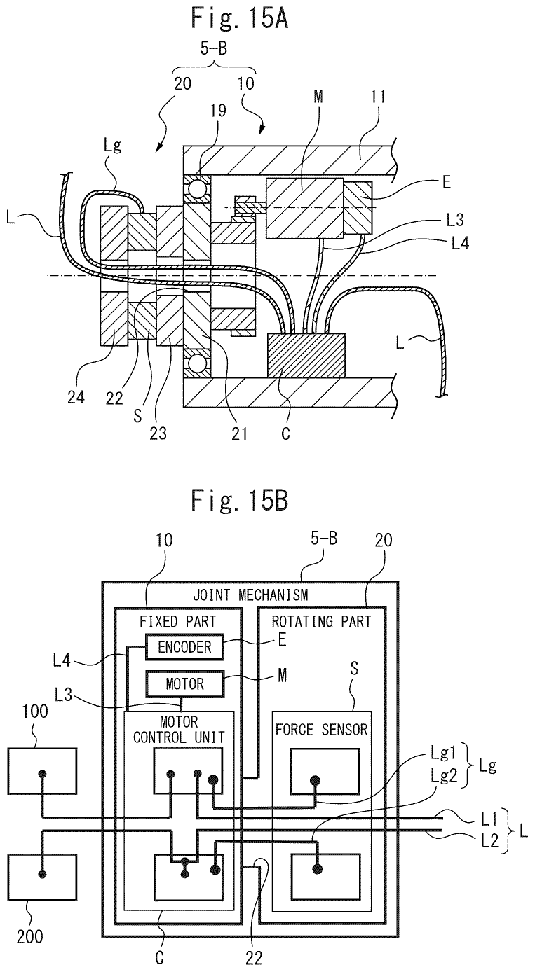

FIG. 15A is a side view of a part of a robot comprising another joint mechanism of the prior art, and FIG. 15B is a block diagram of the other joint mechanism of FIG. 15A. The umbilical member L of the joint mechanism 5-B is generally similar to that shown in FIG. 14A and FIG. 14B. Another umbilical member Lg connects between the force sensor S and the motor control unit C. The other umbilical member Lg comprises a data line Lg1 for connecting the host control unit 100 and the force sensor S, and a power supply bus Lg2 for connecting the power supply unit 200 and the force sensor S. The other umbilical member Lg is an umbilical member having a configuration in which the data line Lg1 and the power supply bus Lg2 are integrally combined.

In the prior art as shown in FIGS. 15A and 15B in this manner, the umbilical members L and Lg each comprise a data line L1, Lg1 and a power supply bus L2, Lg2. Thus, the umbilical members L and Lg are relatively thick.

Specifically, in the prior art, since it is necessary that two relatively thick umbilical members pass through the hollow holes 22 of the joint mechanisms 5-A and 5-B, it is necessary to relatively increase the cross-sectional area of the hollow holes 22. As a result, there is a problem in that the entirety of the joint mechanisms 5-A and 5-B become large in size.

Conversely, in the first embodiment, only a single umbilical member L passes through the hollow hole 22 of the joint mechanism 5. Specifically, in the first embodiment, it is sufficient that only the umbilical member L pass through the hollow hole 22. As a result, in the first embodiment, there is a margin in the cross-sectional area of the hollow hole 22, and it is possible to make the cross-sectional area of the hollow hole 22 relatively small. Thus, the entirety of the joint mechanism 5 can be made compact.

When there is a space in the hollow hole 22 in this manner, it is possible to additionally pass other umbilical members, for example, an umbilical member for supplying fluid or an umbilical member for supplying strong current power, through the hollow hole 22. As a result, it is possible to expand the range of uses of the robot 1 comprising the joint mechanism 5. Furthermore, in the present disclosure, since the umbilical member L passes through the hollow hole 22, there is no need to use a slip ring, and thus, the responsiveness of the umbilical member L is not reduced.

It is preferable that the umbilical member L be supported with a certain degree of slack within the hollow hole 22. As a result, the umbilical member L can be prevented from becoming twisted and damaged when the rotating part 20 of the joint mechanism 5 rotates relative to the fixed part 10.

The robot 1 shown in FIG. 3A comprises first to n-th joint mechanisms 5a to 5n (n is a natural number). Since the joint mechanisms 5a to 5n have the same configuration as the joint mechanism 5 described with reference to FIG. 2, duplicate description thereof has been omitted.

As can be understood from FIG. 3A, the plurality of joint mechanisms 5a to 5n are daisy chain-connected by the umbilical member L. Specifically, the motor control unit C1, force sensor S1, motor control unit C2, force sensor S2, . . . , motor control unit Cn, and force sensor Sn of the joint mechanisms 5a to 5n are daisy-chain connected by the data line L1 of the umbilical member L.

The motor control unit C1, force sensor S1, motor control unit C2, force sensor S2, . . . , motor control unit Cn, and force sensor Sn of the joint mechanisms 5a to 5n are bus-connected by the power supply bus L2 of the umbilical member L. As described above, the data line L1 and the power supply bus L2 pass through hollow holes 22a to 22n of the respective joint mechanisms 5a to 5n as the umbilical member L.

Furthermore, an additional joint mechanism 5(n+1) having a configuration similar to that described above or an end effector 51 is connected to the joint mechanism 5n (refer to FIGS. 3B and 13B). In an example, the end effector 51 comprises a fixed part 101 and a rotating part 201 which rotates relative to the fixed part 101. A hollow hole 221 through which the umbilical member L, etc., can pass is formed in the rotating part 201 in the same manner as described above.

The fixed part 101 comprises a motor Me, an encoder Ee for detecting the position of the motor shaft of the motor Me, and a motor control unit Ce for controlling the motor Me. The rotating part 201 comprises a force sensor Se in the same manner as described above. Alternatively, when the end effector 51 is a hand, the force sensor Se may detect the gripping force of the hand.

As shown in FIG. 3A, the motor control unit Ce and the force sensor Se are daisy-chain connected by the data line L1 extending from the force sensor Sn. The motor control unit Ce and the force sensor Se are bus-connected by the power supply bus L2 extending from the motor control unit Cn.

The configuration of the end effector 51 is not limited to that shown in FIG. 3A, and the end effector 51 may have another configuration, for example, the (n+1)th joint mechanism. Even if an end effector 51 itself is not present, it is included in the scope of the present disclosure. As described above, the joint mechanisms 5a to 5n can be made smaller. Thus, it can be understood that the entire robot 1 comprising the plurality of joint mechanisms 5a to 5n can be made smaller.

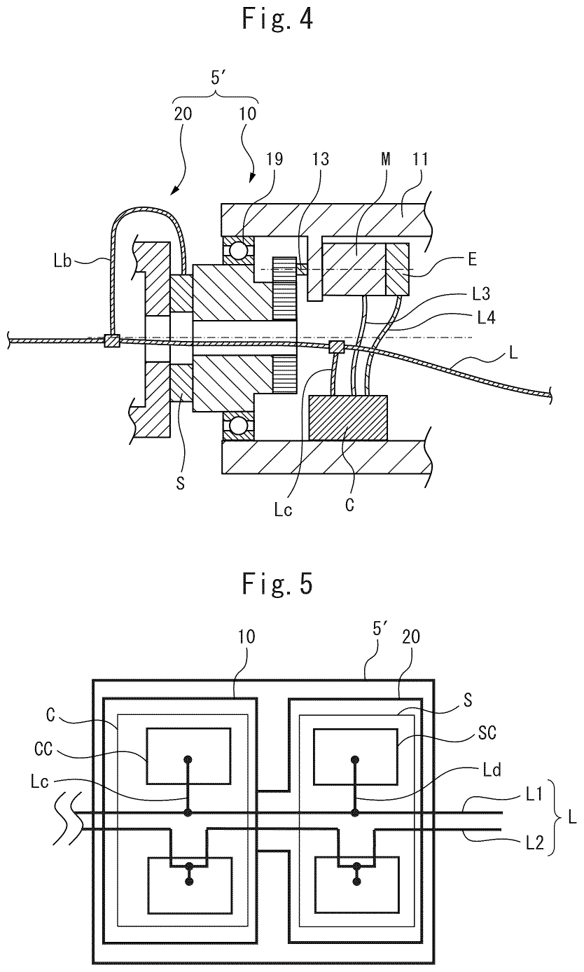

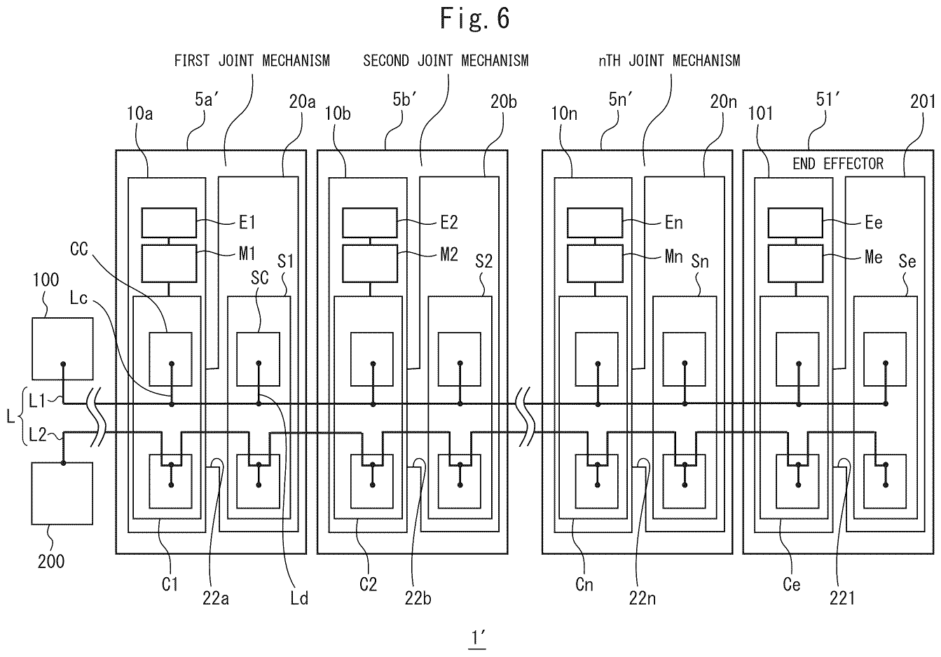

FIG. 4 is a side view of a joint mechanism based on a second embodiment, FIG. 5 is a block diagram of the joint mechanism based on the second embodiment, and FIG. 6 is a block diagram of a robot comprising the joint mechanism of the second embodiment. FIGS. 4 to 6 relating to the second embodiment generally correspond to FIGS. 1 to 3A relating to the first embodiment, respectively. It should be noted that the motor M and the encoder E have been omitted from FIG. 5 and some drawings which are described later.

The joint mechanism 5′ shown in FIG. 4 has a configuration generally similar to that of the joint mechanism 5 of the first embodiment. However, in the second embodiment, data line L1 is bus-connected. Thus, as can be understood from FIGS. 5 and 6, the communication unit CC of the motor control unit C and the data line L1 are connected by an additional data line Le, and the communication unit SC of the force sensor S and the data line L1 are connected by an additional data line Ld. As can be understood from FIG. 6, the other joint mechanisms 5a′ to 5n′ are similar. The data line L1 and the additional data lines Lc and Ld have the same configuration.

In the first and second embodiments, the power supply bus L2 is bus-connected to the motor control unit C and the force sensor S. When the motor control unit C and the force sensor S are bus-connected by the data line L1, the plurality of joint mechanisms receive signals simultaneously. However, by communicating using a protocol such as a predetermined time timing, communication can be performed without signal collisions without an ID indication mechanism (which will be described later). Furthermore, the power supply bus L2 may be connected to the motor control unit C and the force sensor S via a daisy chain connection, in the same manner as the data line L1.

As can be understood from FIG. 6, the plurality of joint mechanisms 5a′ to 5n′ are bus-connected by the umbilical member L. Specifically, the motor control unit C1, force sensor S1, motor control unit C2, force sensor S2, . . . , motor control unit Cn, and force sensor Sn of the joint mechanisms 5a′ to 5n′ are bus-connected by the data line L1 of the umbilical member L.

Furthermore, the motor control unit C1, force sensor S1, motor control unit C2, force sensor S2, . . . motor control unit Cn, and force sensor Sn of the joint mechanisms 5a′ to 5n′ are bus-connected by the power supply bus L2 of the umbilical member L. As described above, the data line L1 and the power supply bus L2 pass through the hollow holes 22a to 22n of the respective joint mechanisms 5a′ to 5n′ as the umbilical member L.

An end effector 51′ is connected to the joint mechanism 5n′. Since the end effector 51′ is similar to the end effector 51, duplicate description thereof has been omitted.

As shown in FIG. 6, the motor control unit Ce and the force sensor Se are bus-connected by the data line L1 extending from the force sensor Sn. Furthermore, the motor control unit Ce and the force sensor Se are bus-connected by the power supply bus L2 extending from the motor control unit Cn.

Furthermore, the configuration of the end effector 51′ is not limited to that shown in FIG. 6, and the end effector 51′ may have other configurations. Furthermore, even if the end effector 51′ itself is not present, it is included in the scope of the present disclosure.

With this configuration, the same effects as those described above can be obtained, and the joint mechanism 5a′, etc., can be made compact. Furthermore, it can be understood that since the plurality of joint mechanisms 5a′ to 5n′ are provided, the entirety of the robot 1′ can be made smaller.

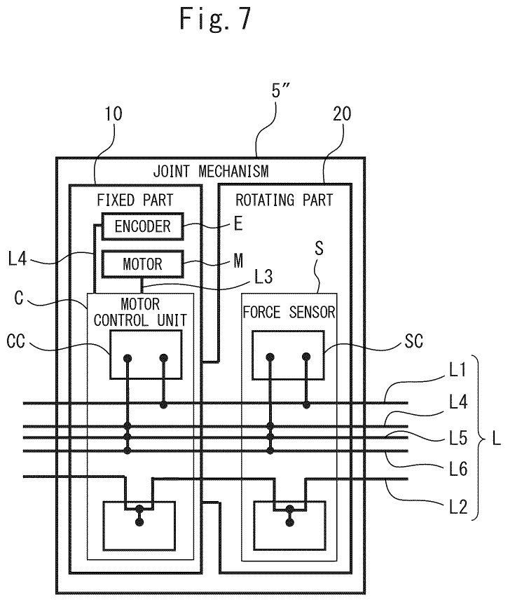

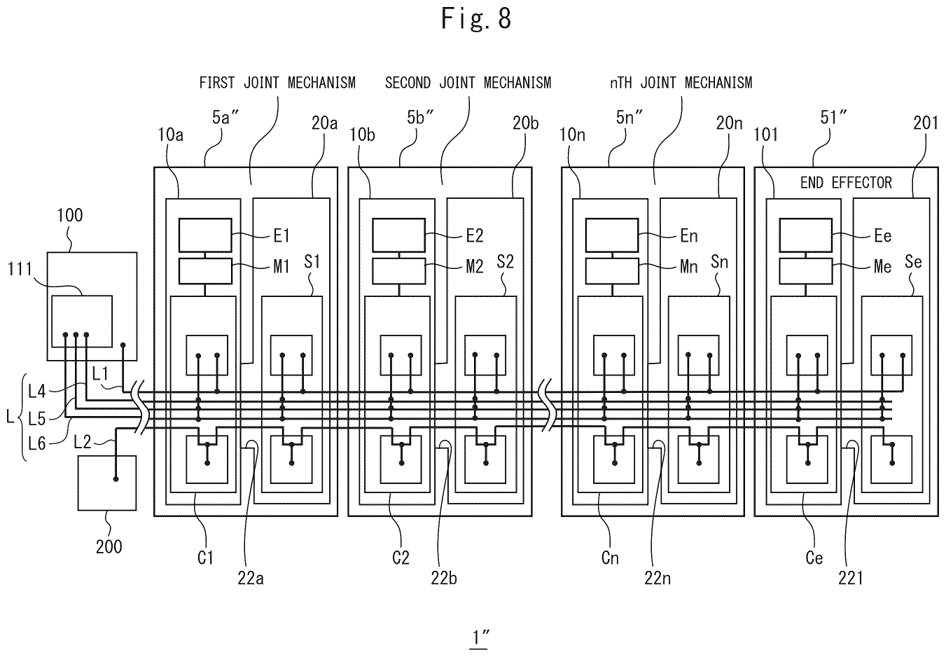

FIG. 7 is a block diagram of a joint mechanism based on a third embodiment, and FIG. 8 is a block diagram of a robot 1″ comprising the joint mechanism of the third embodiment. Since part of the joint mechanism 5″ shown in FIG. 7 has a configuration generally similar to that of the joint mechanism 5′ of the second embodiment, duplicate description thereof may be omitted.

Referring to FIG. 7, the data line L1 is bus-connected to the communication unit CC of the motor control unit C and the communication unit SC of the force sensor S of the joint mechanism 5″. The left end of the data line L1 in FIG. 7 is connected to the host control unit 100 in the same manner as described above, and transmits and receives the various types of data described above between the host control unit 100 and the joint mechanism 5″. Furthermore, the power supply bus L2 is bus-connected to the motor control unit C and force sensor S of the joint mechanism 5″.

A plurality of address buses L4 to L6 are added in FIG. 7. When the robot 1 has plurality of joint mechanisms 5a to 5n, each of the plurality of joint mechanisms 5a to 5n is assigned a unique ID. The address buses L4 to L6 assist in identifying and determining, via the ID, which of the plurality of joint mechanisms 5a to 5n data is intended. Thus, the number of address buses is preferably the minimum number required to individually identify the communication unit CC of the motor control unit C and the communication unit SC of the force sensor S of each joint mechanism.

These address buses L4 to L6 may form an umbilical member L together with the data line L1. Alternatively, it is preferable that the address buses L4 to L6 form an umbilical member L together with the data line L1 and the power supply bus L2.

In the third embodiment shown in FIG. 8, the host control unit 100 comprises an ID indication mechanism 111. The ID indication mechanism 111 outputs a designation signal for designating a specific joint mechanism among the plurality of joint mechanisms 5a to 5n, for example, the communication unit CC of the motor control unit C and the communication unit SC of the sensor S of the joint mechanism 5b, using the address buses L4 to L6. The host control unit 100 then communicates necessary data to the specific joint mechanism designated by the designation signal, for example, the joint mechanism 5b, via the data line L1.

In other words, each of the motor control units C1 to Cn and sensors S1 to Sn of the joint mechanisms 5a to 5n receives and processes the data on the data line L1, or transmits the obtained information of the force sensor S only when it recognizes that it has been designated by the designation signal from the ID indication mechanism 111.

In the third embodiment, the data line L1 and the address buses L4 to L6 are connected in parallel to the communication unit CC of the motor control unit C and the communication unit SC of the sensor S. Thus, it is possible to simultaneously receive the designation signal from the ID indication mechanism 111 and the data via the data line L1 with substantially no time delay.

Furthermore, in FIG. 7, etc., 3-bit parallel lines are used as the address buses L4 to L6. However, addresses may be identified by encoding the designation signal using a smaller number of address buses. Alternatively, the address buses L4 to L6 may be eliminated, and the designation signal may be transmitted and received by superimposing ID designation information on the data line L1 using a specific protocol. In FIG. 8, it is also possible to multiplex and share the force sensor S, thereby reducing the thickness and weight of the umbilical member L.

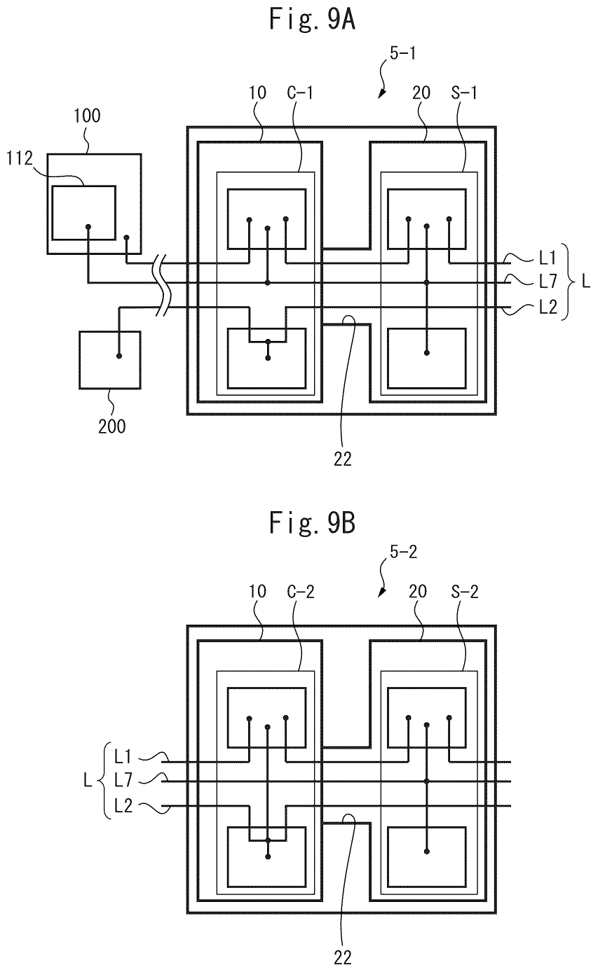

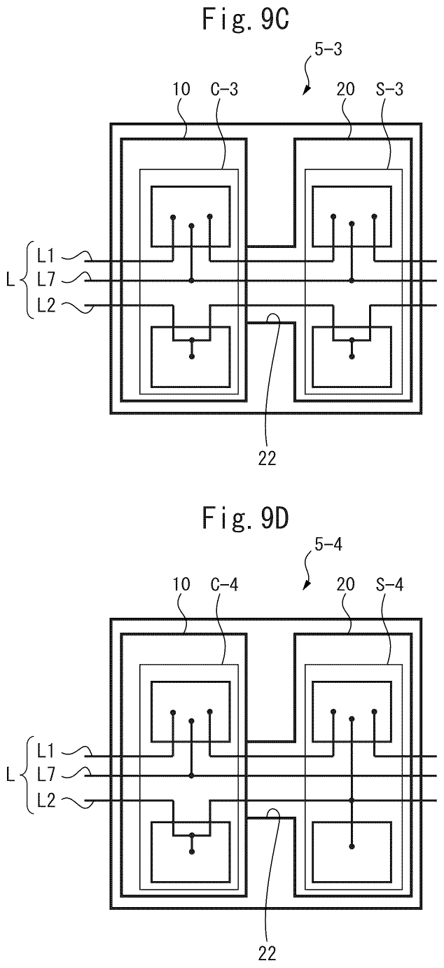

FIG. 9A is a view showing a first modification example, in which the umbilical member comprises a control communication power supply bus. The joint mechanism 5-1 shown in FIG. 9A has a configuration generally similar to that of the joint mechanism 5 shown in FIG. 2. However, the power supply bus L2 is connected only to the motor control unit C-1, and is not connected to the force sensor S-1. Thus, the power supply bus L2 does not supply current to the force sensor S-1.

The umbilical member L shown in FIG. 9A comprises a control communication power supply bus L7 in addition to the data line L1 and the power supply bus L2. The control communication power supply bus L7 is connected to a control communication power supply unit 112 provided in the host control unit 100. The control communication power supply bus L7 supplies the current required by the force sensor S during detection and the current required for circuits (not illustrated) used when acquiring the detected data via the control communication power supply unit 112. In other words, the control communication power supply bus L7 supplies current to the force sensor S-1 via the control communication power supply unit 112. It should be noted that in FIGS. 9B to 9D, which are described later, the host control unit 100 comprises the control communication power supply unit 112 and the control communication power supply bus L7 is connected to the control communication power supply unit 112.

In FIG. 9A, even if the power supply unit 200 is disabled for safety purposes, the detection action by the force sensor S and the servo position are maintained through the control communication power supply unit 112 of the host control unit 100 and the control communication power supply bus L7 via the control communication power supply bus L7. Thus, driving for operations becomes possible immediately after the power supply unit 200 is again energized.

FIG. 9B is a view showing a second modification example, in which the umbilical member comprises a control communication power supply bus. The joint mechanism 5 shown in FIG. 9B to FIG. 9D is connected to the host control unit 100 and the power supply unit 200 in the same manner as shown in FIG. 9A. In FIG. 9B, the motor control unit C-2 obtains current via the power supply bus L2. The force sensor S-2 obtains the current required to operate the force sensor S-2 via the power supply bus L2, and obtains the current required for control/communication of the force sensor S-2 via the control communication power supply bus L7.

The force sensor S may be impacted by noise generated by the power supply bus L2. It is advantageous to reduce this noise by obtaining the current required to operate the force sensor S-2 from the control communication power supply bus L7 (FIG. 9A) or obtaining only the current required to operate the force sensor S-2 via the power supply bus L2 (FIG. 9B).

FIG. 9C is a view showing a third modification example, in which the umbilical member comprises a control communication power supply bus. In FIG. 9C, both the motor control unit C-3 and the force sensor S-3 obtain the necessary current via the control communication power supply bus L7. Thus, even if the power supply unit 200 is disabled in an emergency, operation of the motor control unit C-3 and the force sensor S-3 can be maintained. Even if the power supply bus L2 is disabled, the motor control unit C-3 need only maintain position information and settings other than those for driving the motor via the power supply bus L7, and when the force sensor S-3 need not be reconfigured when the power is restored, there are no problem regarding supplying excitation power supply for the strain gauge and the indicator light from the power supply bus L2, which can contribute to power saving. If such an effect cannot be expected, the power supply bus L2 may not be connected to the motor control unit C and the force sensor S, or the power supply bus L2 itself may be eliminated.

FIG. 9D is a view showing a fourth modification example, in which the umbilical member comprises a control communication power supply bus. The force sensor S-4 obtains the necessary current via the power supply bus L2. And the motor control unit C-4 obtains the necessary current via the control communication power supply bus L7. The configuration shown in FIG. 9D is advantageous when the force sensor S-4 requires a relatively large current, for example, when the force sensor S-4 requires an excitation power source or when it has a magnetic bearing. Even if the power supply unit 200 is disabled in an emergency, operation of the motor control unit C-4 is maintained via the control communication power supply bus L7.

In order to monitor whether the robot 1 has stopped in a safe state after the power supply unit 200 has been disabled, it is necessary that some of the joint mechanisms, such as the first joint mechanism 5a and the (n+1)th joint mechanism 51, continue to operate the force sensors thereof. The configurations shown in FIGS. 9A to 9D are advantageous in such cases.

Alternatively, only the communication function parts of the motor control unit C and the force sensor S may be powered by a communication power source (not illustrated). In that case, even if the power supply unit 200 is disabled, the motor control unit C and the force sensor S not only maintain their functions but also maintain communication with the host control unit 100, which has the effect of making it easier to safely restore the situation.

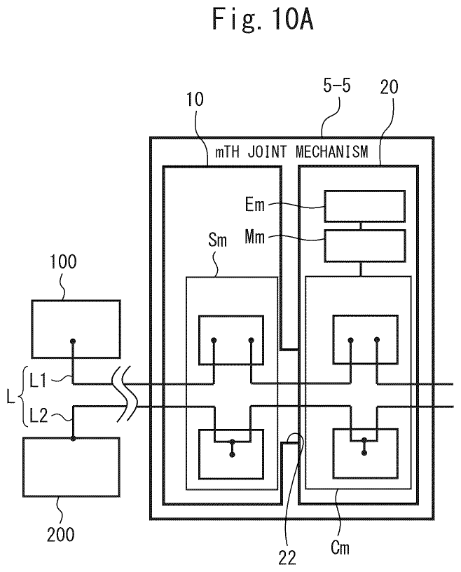

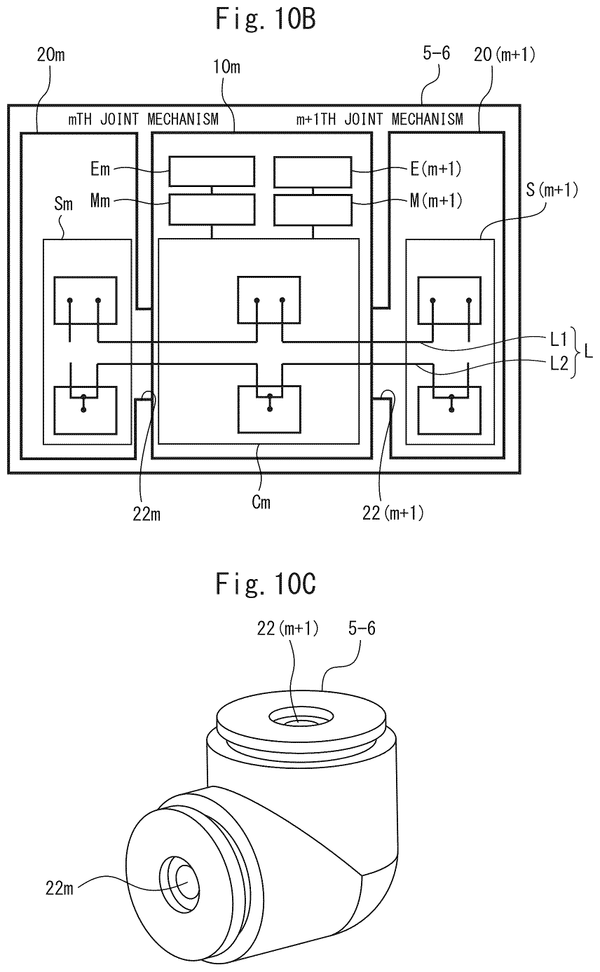

FIG. 10A is a block diagram of a joint mechanism of another modification example. FIG. 10A shows an mth axis joint mechanism 5-5 (“m” is a natural number between “1” and “n”). In the joint mechanism 5-5, a force sensor Sm (“m” is the same as described above, and the same applies hereinafter) is arranged in the fixed part 10, and a motor Mm, an encoder Em, and a motor control unit Cm are arranged in the rotating part 20. Further, the umbilical member L is inserted into the hollow hole 22 formed in the fixed part 10.

As shown in FIG. 10A, the rotating part 20 may comprise the motor Mm and the encoder Em, and the fixed part 10 may comprise the force sensor Sm and the motor control unit Cm. In the same manner, as shown in FIG. 2, the fixed part 10 may comprise motor Mm and the encoder Em, and the rotating part 20 may comprise the force sensor Sm and the motor control unit Cm. Even with these configurations, the same effects as those described above can be obtained, and they are included in the scope of the present disclosure.

In FIG. 10A, the data line L1 of the umbilical member L daisy chain-connects the motor control unit Cm and the force sensor Sm, but the data line L1 may bus-connect the motor control unit Cm and the force sensor Sm. It is clear that even such a case is within the scope of the present disclosure.

FIG. 10B is a block diagram of a joint mechanism of yet another modification example. FIG. 10C is a perspective view of the joint mechanism shown in FIG. 10B. The joint mechanism 5-6 shown in FIG. 10B comprises one fixed part 10m and two rotating parts 20m and 20(m+1) (“m” is a natural number between “1” and “n”). Specifically, the joint mechanism 5-6 serves as both the mth joint mechanism and the (m+1)th joint mechanism.

As shown in the drawing, the rotating part 20m is rotatably engaged with one end of the fixed part 10m, and the rotating part 20(m+1) is rotatably engaged with the other end of the fixed part 10m. The umbilical member L enters the inside of the fixed part 10m through the hollow hole 22m of the rotating part 20m, and extends to the outside through the hollow hole 22(m+1) of the rotating part 20(m+1). Specifically, the umbilical member L passes through both the hollow hole 22m and the hollow hole 22(m+1). Thus, it is preferable that a hollow hole also be formed in the fixed part 10. It is also preferable that the hollow holes 22m and 22(m+1) not be parallel to each other or be parallel but offset from each other (refer to FIG. 10C).

The fixed part 10m comprises the motor Mm and the encoder Em for the rotating part 20m, and a motor M(m+1) and an encoder E(m+1) for the rotating part 20(m+1). The motor control unit Cm of the fixed part 10m serves to control both the motor Mm for the mth axis and the motor M(m+1) for the (m+1)th axis.

In such a configuration, some of the components of the joint mechanism 5-6, such as a part of the housing 11 and the motor control unit Cm, can be shared between the mth axis and the (m+1)th axis, and thus it can be understood that the joint mechanism 5-6 and the robot 1 can be made even smaller and lighter.

Although the data line L1 of the umbilical member L daisy-chain connects the motor control unit Cm and the force sensors Sm and S(m+1) in FIG. 10B, the data line L1 may bus-connect the motor control unit Cm and the force sensors Sm and S(m+1). It is clear that even such a case is included in the scope of the present disclosure.

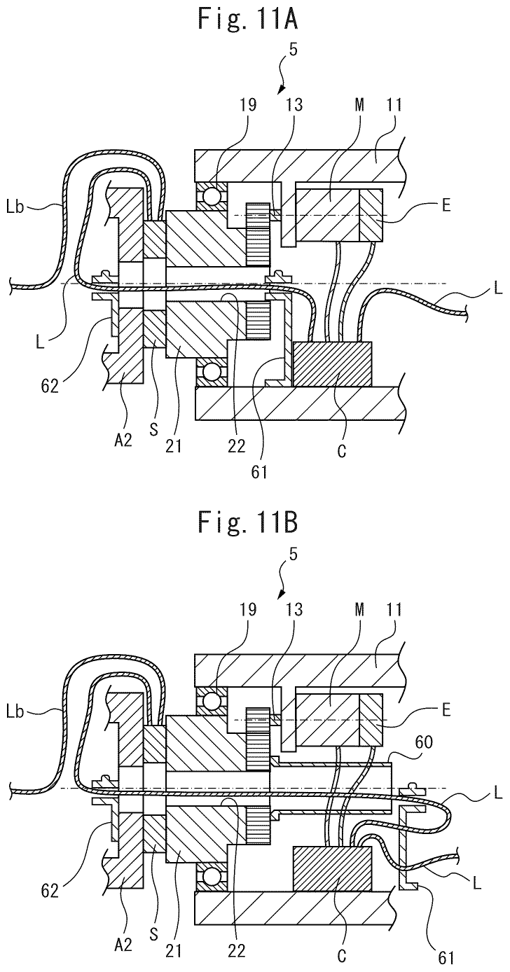

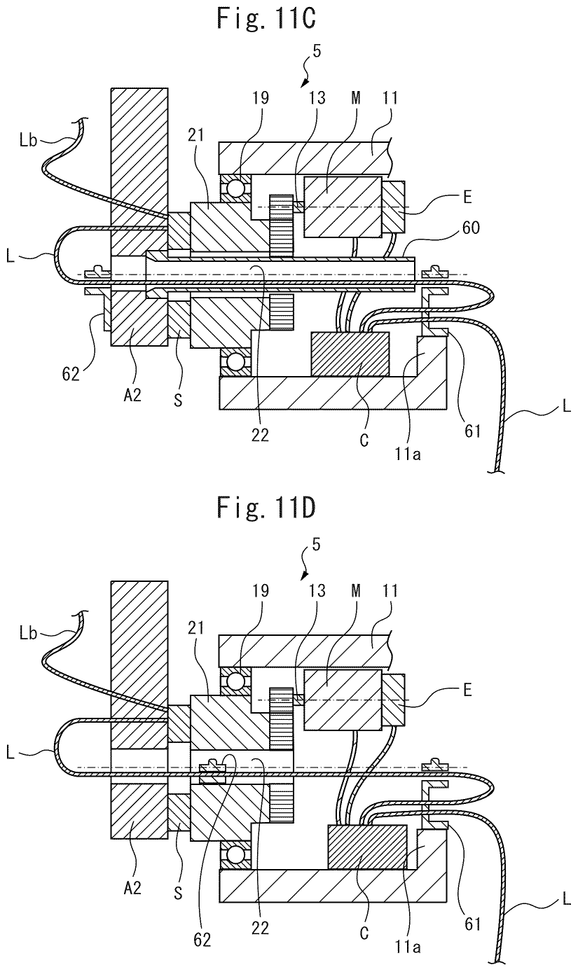

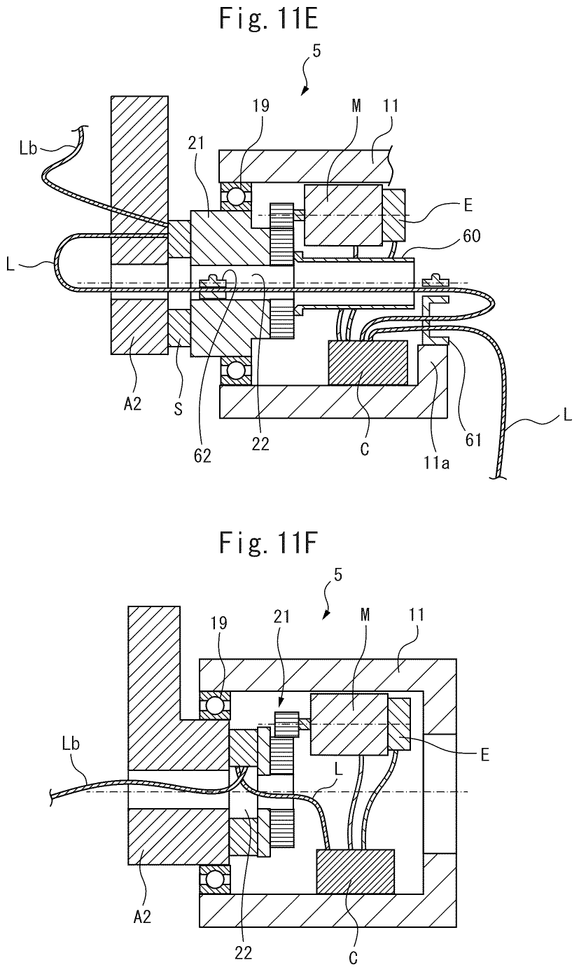

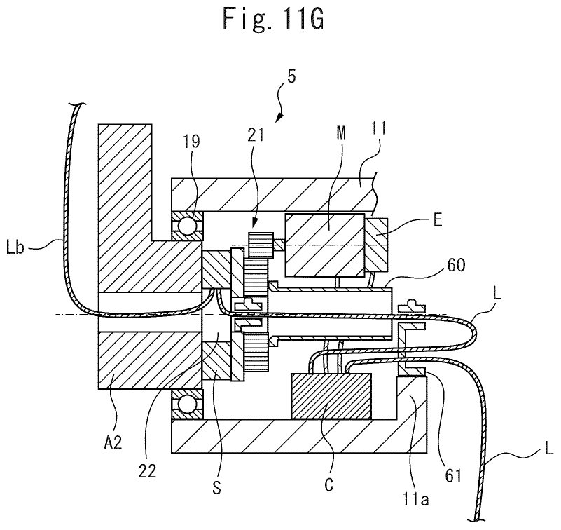

FIG. 11A is a side view of a part of a robot comprising a joint mechanism based on a fourth embodiment. In FIG. 11A, the force sensor S is directly connected between the speed reducer 21 and the link A2. The speed reducer 21, the force sensor S, and the link A2 form a common hollow hole 22.

As shown in FIG. 11A, a first clamp member 61 is provided on the inner peripheral surface of the housing 11 between the motor control unit C and the speed reducer 21. Furthermore, a second clamp member 62 is provided at a position outward of the force sensor S. In FIG. 11A, the second clamp member 62 is provided on the surface of the link A2 positioned on the side opposite to the surface to which the force sensor S is joined.

The tips of the first clamp member 61 and the second clamp member 62 extend to positions corresponding to the internal space of the hollow hole 22. The tips of the first clamp member 61 and the second clamp member 62 preferably extend to the vicinity of the center of rotation of the joint mechanism 5. The tips of the first clamp member 61 and the second clamp member 62 are provided with a gripping portion for securing the umbilical member L, for example, clips for clamping the umbilical member L. Thus, the umbilical member L is gripped by the first clamp member 61 and the second clamp member 62 in the internal space of the hollow hole 22. Since the umbilical member L also rotates and twists when the rotating part 20 rotates, the umbilical member L is gripped with a certain degree of slack.

FIG. 11B is a view showing an example of the first modification in the fourth embodiment. In FIG. 11B, a pipe member 60 is affixed to the speed reducer 21 in the housing 11. The central axis of the pipe member 60 is preferably coaxial with the central axis of the hollow hole 22, and the inner diameter of the pipe member 60 is preferably approximately equal to the inner diameter of the hollow hole 22. The inner surface of the pipe member 60 is smooth, and the pipe member 60 is supported in the housing 11 by another support member (not illustrated). In FIG. 11B, the first clamp member 61 is provided adjacent to one end of the pipe member 60.

In FIG. 11B, the umbilical member L passes through the hollow hole 22 and the pipe member 60 while being held by the first clamp member 61 and the second clamp member 62. Thus, as compared to the case shown in FIG. 11A, the umbilical member L has a margin for twisting. Furthermore, although the umbilical member L twists when the rotating part 20 rotates, the pipe member 60 does not rotate. Thus, the umbilical member L is less likely to get caught in the hollow hole 22 and the pipe member 60. Since the umbilical member L passes through the pipe member 60, the pipe member 60 serves as a protective tube for protecting the umbilical member L. This is also true in the embodiments described below.

FIG. 11C is a view showing a second modification example of the fourth embodiment. In FIG. 11C, the pipe member 60 is inserted into the hollow hole 22 from the force sensor S side (link A2 side). The tip of the pipe member 60 is positioned near the first clamp member 61, and the base end of the pipe member 60 is positioned near the force sensor S. In FIG. 11C, etc., the first clamp member 61 is provided in a protrusion 11a provided on the inner surface of the housing 11.

FIG. 11D is a view showing a third modification example of the fourth embodiment. In FIG. 11D, the second clamp member 62 is provided on the inner circumferential surface of the hollow hole 22 of the speed reducer 21. In this case, by providing the second clamp member 62 at a position closer to the first clamp member 61 than the force sensor S of the rotating part 20, the influence of the torsional reaction force of the umbilical member L, which rotates and twists when the rotating part 20 rotates, on the accuracy of the force sensor S is reduced.

FIG. 11E is a view showing a fourth modification example of the fourth embodiment. In FIG. 11E, the second clamp member 62 is provided on the inner circumferential surface of the hollow hole 22 of the speed reducer 21. Furthermore, a pipe member 60 similar to that described in FIG. 11B is provided. Such a case is also included in the scope of the present disclosure.

FIG. 11F is a view showing a fifth modification example of the fourth embodiment. In FIG. 11F, a part of the link A2 is rotatably engaged with the bearing 19, and the speed reducer 21 is not engaged with the bearing 19. The force sensor S is coupled to the link A2 inside the housing 11.

The umbilical member L extending from the motor control unit C is connected to the force sensor S through the hollow hole 22. Another umbilical member Lb extending from the force sensor S extends to the outside of the link A2 through the hollow hole 22. As described above, the umbilical member Lb is an umbilical member comprising the data line L1 and the power supply bus L2, in the same manner as the umbilical member L.

In this configuration, two umbilical members L and Lb are present within the hollow hole 22. However, the umbilical member L extends only between the force sensor S and the motor control unit C, and the other umbilical member Lb extends only between the force sensor S and the outside of the link A2. Thus, in any cross section of the hollow hole 22 with respect to the rotation axis of the joint mechanism 5, only one of the umbilical member L and the umbilical member Lb is present. Thus, it can be seen that the same effects as described above can be obtained with the configuration shown in FIG. 11E.

FIG. 11G is a view showing a sixth modification example of the fourth embodiment. In FIG. 11G, a pipe member 60, a first clamp member 61, and a second clamp member 62 similar to those described above are added to the configuration shown in FIG. 11F. Such a case is also included in the scope of the present disclosure.

For ease of understanding, in FIGS. 11E and 11F, the two umbilical members L and Lb are depicted as intersecting near the force sensor S. However, in reality, it is not necessary that the two umbilical members L and Lb intersect near the force sensor S.

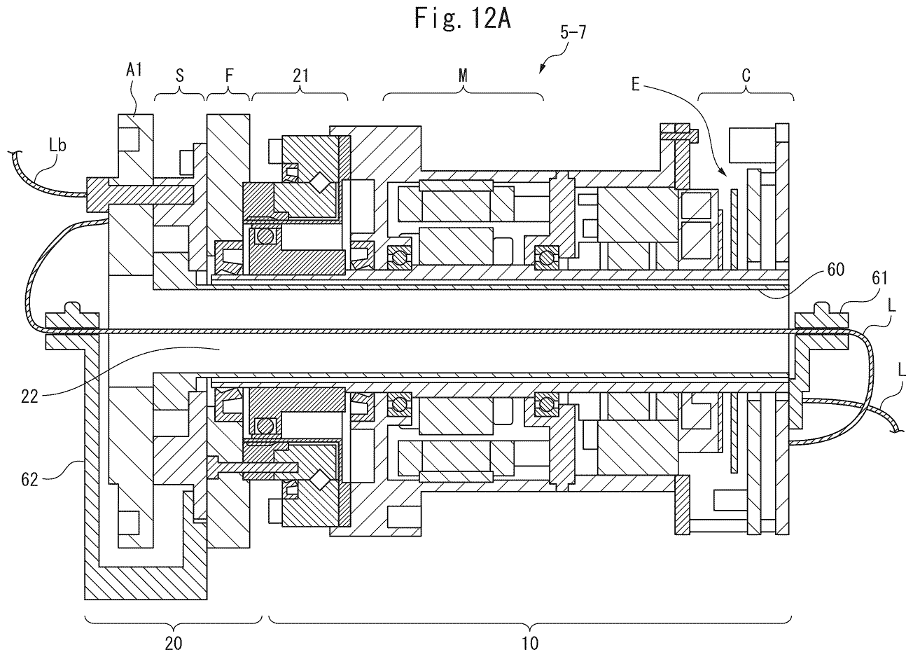

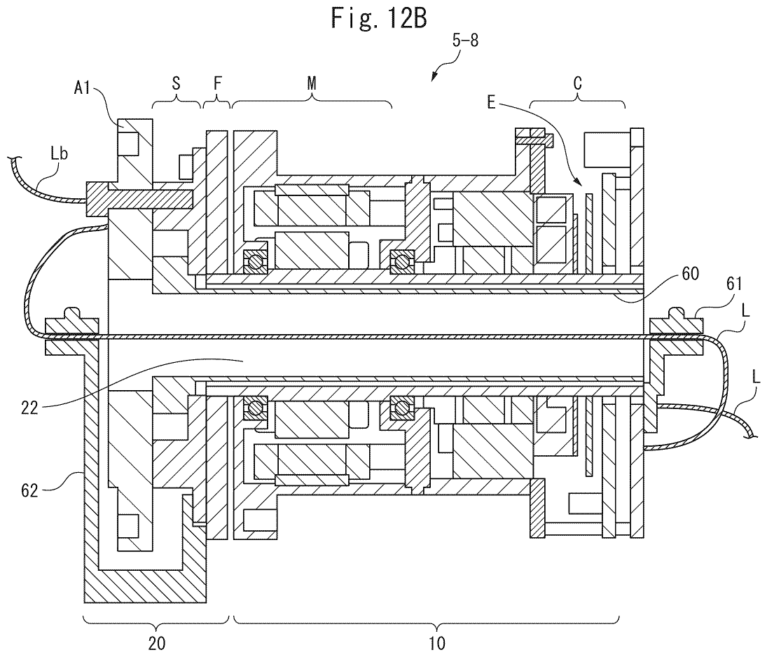

FIG. 12A is a side view of a part of a robot comprising a joint mechanism of a fifth embodiment. The joint mechanism 5-7 shown in FIG. 12A comprises the motor M, the encoder E for detecting the rotational position of the motor shaft of the motor M, the speed reducer 21 for decelerating the rotation of the motor M, and the force sensor S for detecting the force around the output shaft of the speed reducer 21. The motor control unit C is connected to the motor M. The force sensor S is also connected to the output shaft of the speed reducer 21 via an adapter flange F.

In the embodiment shown in FIG. 12A, the combination of the motor control unit C, the encoder E, the motor M, and the speed reducer 21 corresponds to the fixed part 10, and the combination of the adapter flange F and the force sensor S corresponds to the rotating part 20. However, the fixed part 10 need not necessarily include the speed reducer 21, and the rotating part 20 need not necessarily include the adapter flange F.

In FIG. 12A, the speed reducer 21 is preferably a wave gear device. As a result, the motor shaft of the motor M and the input/output shaft of the speed reducer 21 can be arranged coaxially. Thus, a common hollow hole 22 can be formed in the motor control unit C, the encoder E, the motor M, the speed reducer 21, the adapter flange F, and the force sensor S. In other words, in the embodiment shown in FIG. 12A, the common hollow hole 22 is formed in both the fixed part 10 and the rotating part 20. In other words, the hollow hole 22 is formed in the joint mechanism 5.

It is preferable that a pipe member 60 similar to that described above be inserted into the hollow hole 22. Although the length of the pipe member 60 is shorter than that of the hollow hole 22, the length of the pipe member 60 may be equal to or greater than that of the hollow hole 22. The pipe member 60 is affixed to the rotating part 20, and thus, when the rotating part 20 rotates, the pipe member 60 itself rotates together with the rotating part 20. It should be noted that even the case wherein the pipe member 60 is excluded is encompassed within the scope of the fifth embodiment.

An umbilical member L similar to that described above passes through the inside of the pipe member 60. Furthermore, the first clamp member 61 is provided on the motor control unit C, and the tip thereof extends to one end of the hollow hole 22. It is preferable that a gap be formed between the tip of the first clamp member 61 and the motor control unit C.

The second clamp member 62 provided on the adapter flange F is curved beyond the force sensor S, and the tip thereof extends to the other end of the hollow hole 22. In order to prevent a decrease in the sensitivity of the force sensor S, it is preferable that the second clamp member 62 not directly contact the force sensor S, and a gap be formed between the second clamp member 62 and the force sensor S.

As shown in FIG. 12A, the tip of the first clamp member 61 and the tip of the second clamp member 62 are preferably positioned on the central axis of the hollow hole 22. The umbilical member L is gripped inside the hollow hole 22 by the first clamp member 61 and the second clamp member 62.

Even in such a case, it is clear that the same effects as described above can be obtained. Furthermore, when a strain wave gear device is used as the speed reducer 21, an additional effect in that the outer diameter of the joint mechanism 5-7 can be reduced is obtained.

Furthermore, FIG. 12B is a view showing a modification example of the fifth embodiment. The joint mechanism 5-8 shown in FIG. 12B comprises the motor control unit C, the encoder E, the motor M, the adapter flange F, and the force sensor S. In FIG. 12B, the adapter flange F is connected to the output shaft of the motor M.

In the embodiment shown in FIG. 12B, the combination of the motor control unit C, the encoder E, and the motor M corresponds to the fixed part 10, and the combination of the adapter flange F and the force sensor S corresponds to the rotating part 20.

In FIG. 12B, the motor M is preferably a direct drive motor. By using a direct motor drive, the speed reducer can be eliminated. Thus, a common hollow hole 22 can be formed in the motor control unit C, the encoder E, the motor M, the adapter flange F, and the force sensor S. In other words, in the embodiment shown in FIG. 12B, the common hollow hole 22 is formed in both the fixed part 10 and the rotating part 20. In other words, the hollow hole 22 is formed in the joint mechanism 5.

The pipe member 60 is inserted into the hollow hole 22, and the umbilical member L passing through the pipe member 60 is likewise gripped by the first clamp member 61 and the second clamp member 62.

Even in such a case, it is clear that the same effects as described above can be obtained. Furthermore, in the embodiment shown in FIG. 12B, by adopting a direct drive motor, the speed reducer can be eliminated. Thus, it is possible to obtain the additional effects in that the weight of the joint mechanism 5-8 can be reduced and the outer diameter of the joint mechanism 5-8 can be reduced.

As an effect of at least one of the embodiments described above, the number of umbilical members L passing through the hollow hole 22 is reduced, providing a margin in the cross-sectional area of the hollow hole 22. Thus, the hollow hole 22 can be made smaller, and as a result, the entire robot comprising the joint mechanism can be made smaller. Furthermore, it is also possible to pass additional umbilical members through the hollow hole 22.

Although the embodiments of the present disclosure have been described in detail above, the present disclosure is not limited to the individual embodiments described above. These embodiments can be variously added, replaced, modified, partially deleted, etc., within the scope of the spirit of the invention, or within the scope of the idea and intent of the present invention derived from the contents described in the claims and their equivalents. For example, in the embodiments described above, the order of each operation and the order of each process are shown as examples, and are not limited to these. The same applies when numerical values or formulas are used in the description of the embodiments described above. Furthermore, appropriate combinations of some of the embodiments described above are included in the scope of the present disclosure.

Regarding the embodiments and modification examples described above, the following addendums are further disclosed.

### (Addendum 1)

A joint mechanism (5, 5′, 5″, 5a to 5n, 5-1 to 5-8), comprising:
a fixed part (10),
a rotating part (20) which rotates relative to the fixed part (10),
a motor (M) which is arranged in one of the fixed part (10) and the rotating part (20),
a motor control unit (C, C1 to C4) for controlling the motor (M),
a force sensor (S, S1 to S4) which is arranged in the other of the fixed part (10) and the rotating part (20), for detecting a force acting around a joint axis of the joint mechanism (5, 5′, 5″, 5a to 5n, 5-1 to 5-8), and
a single umbilical member (L) which is connected to the motor control unit (C, C1 to C4) and the force sensor (S, S1 to S4), wherein
the umbilical member (L) passes through a hollow hole (22) formed in at least a portion of the joint mechanism (5, 5′, 5″, 5a to 5n, 5-1 to 5-8).

### (Addendum 2)

The joint mechanism (5, 5′, 5″, 5a to 5n, 5-1 to 5-8) according to Addendum 1, wherein the single umbilical member (L) comprises at least one of a data line (L1) for transmitting and receiving control information related to the motor (M) and detected information detected by the force sensor (S, S1 to S4), and a power supply bus (L2) for supplying current to the motor control unit (C, C1 to C4) and the force sensor (S, S1 to S4).

### (Addendum 3)

The joint mechanism (5, 5′, 5″, 5a to 5n, 5-1 to 5-8) according to Addendum 1 or 2, wherein the single umbilical member (L) is bus-connected or daisy chain-connected between the motor control unit (C, C1 to C4) and the force sensor (S, S1 to S4).

### (Addendum 4)

The joint mechanism (5, 5′, 5″, 5a to 5n, 5-1 to 5-8) according to any one of Addendums 1 to 3, wherein the single umbilical member (L) is twisted inside the hollow hole (22).

### (Addendum 5)

The joint mechanism (5, 5′, 5″, 5a to 5n, 5-1 to 5-8) according to any one of Addendums 1 to 4, wherein a pipe member (60) is inserted into the hollow hole (22) and the single umbilical member (L) passes through the pipe member (60).

### (Addendum 6)

The joint mechanism (5, 5′, 5″, 5a to 5n, 5-1 to 5-8) according to any one of Addendums 1 to 5, wherein control information related to the motor (M) and detected information of the force sensor (S, S1 to S4) are communicated using the same protocol.

### (Addendum 7)

The joint mechanism (5, 5′, 5″, 5a to 5n, 5-1 to 5-8) according to any one of Addendums 1 to 6, wherein the umbilical member (L) is supported with slack inside the hollow hole (22).

### (Addendum 8)

A robot (1, 1′, 1″), comprising:
a plurality of joint mechanisms (5, 5′, 5″, 5a to 5n, 5-1 to 5-8), wherein
each of the plurality of joint mechanisms (5, 5′, 5″, 5a to 5n, 5-1 to 5-8) comprises:
a fixed part (10),
a rotating part (20) which rotates relative to the fixed part (10),
a motor (M) which is arranged in one of the fixed part (10) and the rotating part (20),
a motor control unit (C, C1 to C4) for controlling the motor (M), and
a force sensor (S, S1 to S4) which is arranged in the other of the fixed part (10) and the rotating part (20), for detecting a force acting around a joint axis of the joint mechanism (5, 5′, 5″, 5a to 5n, 5-1 to 5-8),
the robot (1, 1′, 1″) further comprises a single umbilical member (L) which is connected to
the motor control unit (C, C1 to C4) and the force sensor (S, S1 to S4) of each of the plurality of joint mechanisms (5, 5′, 5″, 5a to 5n, 5-1 to 5-8), and
the umbilical member (L) passes through a hollow hole (22) formed in at least a portion of each of the plurality of joint mechanisms (5, 5′, 5″, 5a to 5n, 5-1 to 5-8).

### (Addendum 9)

The robot (1, 1′, 1″) according to Addendum 8, wherein the umbilical member (L) comprises at least one of a data line (L1) for transmitting and receiving control information related to the motor (M) and detected information detected by the force sensor (S, S1 to S4), and a power supply bus (L2) for supplying current to the motor control unit (C, C1 to C4) and the force sensor (S, S1 to S4),
the robot further comprising:
a power supply unit (200) for supplying current to at least one of the motor control unit (C, C1 to C4) and the force sensor (S, S1 to S4) of each of the plurality of joint mechanisms (5, 5′, 5″, 5a to 5n, 5-1 to 5-8) via the power supply bus (L2), and
a host control unit (100) for inputting and outputting the control information and the detected information to both the motor control unit (C, C1 to C4) and the force sensor (S, S1 to S4) of the plurality of joint mechanisms (5, 5′, 5″, 5a to 5n, 5-1 to 5-8) via the data line (L1).

### (Addendum 10)

The robot (1, 1′, 1″) according to Addendum 9, wherein the host control unit (100) includes an indication mechanism (111), and
the indication mechanism (111) selects at least one of the motor control unit (C, C1 to C4) and the force sensor (S, S1 to S4) of a specific joint mechanism among the plurality of joint mechanisms (5, 5′, 5″, 5a to 5n, 5-1 to 5-8) and outputs an instruction via the data line (L1).

### (Addendum 11)

The robot (1, 1′, 1″) according to Addendum 10, wherein the single umbilical member (L) comprises a plurality of address buses (L4 to L6), and the indication mechanism (111) outputs the instruction to the specific joint mechanism using the plurality of address buses (L4 to L6).

Reference Signs List

| | |
|---|---|
| 1, 1′, 1″ | robot |
| 5, 5′, 5″, | joint mechanism |
| 5a to 5n, | |
| 5-1 to 5-8 | |
| 10 | fixed part |
| 11 | housing |
| 11a | protrusion |
| 13 | output shaft |
| 19 | bearing |
| 20 | rotating part |
| 21 | speed reducer |
| 22 | hollow hole |
| 23 | first connection member |
| 24 | second connection member |
| 51 | end effector |
| 60 | pipe member |
| 61 | first clamp member |
| 62 | second clamp member |
| 100 | host control unit |
| 111 | ID indication mechanism |
| 112 | control communication |
| | power supply unit |
| 200 | power supply unit |
| C, C1 to C4 | motor control unit |
| CC, SC | communication unit |
| E | encoder |
| L | umbilical member |
| L1 | data line |
| L2 | power supply bus |
| L4 to L6 | address bus |
| L7 | control communication |
| | power supply bus |
| M | motor |
| S, S1 to S4 | sensor |

1: A joint mechanism, comprising:
a fixed part,
a rotating part which rotates relative to the fixed part,
a motor which is arranged in one of the fixed part and the rotating part,
a motor control unit for controlling the motor,
a force sensor which is arranged in the other of the fixed part and the rotating part, for detecting a force acting around a joint axis of the joint mechanism, and
a single umbilical member which is connected to the motor control unit and the force sensor, wherein
the umbilical member passes through a hollow hole formed in at least a portion of the joint mechanism.

2: The joint mechanism according to claim 1, wherein the single umbilical member comprises at least one of a data line for transmitting and receiving control information related to the motor and detected information detected by the force sensor, and a power supply bus for supplying current to the motor control unit and the force sensor.

3: The joint mechanism according to claim 1, wherein the single umbilical member is bus-connected or daisy chain-connected between the motor control unit and the force sensor.

4: The joint mechanism according to claim 1, wherein the single umbilical member is twisted inside the hollow hole.

5: The joint mechanism according to claim 1, wherein a pipe member is inserted into the hollow hole and the single umbilical member passes through the pipe member.

6: The joint mechanism according to claim 1, wherein control information related to the motor and detected information of the force sensor are communicated using the same protocol.

7: The joint mechanism according to claim 1, wherein the umbilical member is supported with slack inside the hollow hole.

8: A robot, comprising:
a plurality of joint mechanisms, wherein
each of the plurality of joint mechanisms comprises:
a fixed part,
a rotating part which rotates relative to the fixed part,
a motor which is arranged in one of the fixed part and the rotating part,
a motor control unit for controlling the motor, and
a force sensor which is arranged in the other of the fixed part and the rotating part, for detecting a force acting around a joint axis of the joint mechanism,
the robot further comprises a single umbilical member which is connected to the motor control unit and the force sensor of each of the plurality of joint mechanisms, and
the umbilical member passes through a hollow hole formed in at least a portion of each of the plurality of joint mechanisms.

9: The robot according to claim 8, wherein the single umbilical member comprises at least one of a data line for transmitting and receiving control information related to the motor and detected information detected by the force sensor, and a power supply bus for supplying current to the motor control unit and the force sensor,
the robot further comprising:
a power supply unit for supplying current to at least one of the motor control unit and the force sensor of each of the plurality of joint mechanisms via the power supply bus, and
a host control unit for inputting and outputting the control information and the detected information to both the motor control unit and the force sensor of the plurality of joint mechanisms via the data line.

10: The robot according to claim 9, wherein the host control unit includes an indication mechanism, and
the indication mechanism selects at least one of the motor control unit and the force sensor of a specific joint mechanism among the plurality of joint mechanisms and outputs an instruction via the data line.

11: The robot according to claim 10, wherein the single umbilical member comprises a plurality of address buses, and the indication mechanism outputs the instruction to the specific joint mechanism using the plurality of address buses.
